(19) United States
(12) Patent Application Publication
(10) Pub. No.: US 2011/0175306 A1
(43) Pub. Date: Jul. 21, 2011

(54) RECLINABLE STROLLER SEAT

(75) Inventor: Daniel Nelson Newhard, Lititz, PA (US)

(73) Assignee: CHICCO USA, INC., Lancaster, PA (US)

(21) Appl. No.: 12/689,480

(22) Filed: Jan. 19, 2010

(51) Int. Cl. B62B 9/12; B60N 2/235; B62B 7/00

(52) U.S. Cl. 280/47.4; 297/364; 297/354.13

(57) ABSTRACT

A stroller having a reclinable seat is provided, the reclinable seat includes a base connected to the stroller, a seatback pivotally connected to the stroller, and a seat recline mechanism arranged on the seatback. The seat recline mechanism includes a body defining a cavity having grooves and a release slider arranged within the cavity. The release slider has teeth that correspond to the grooves in the cavity and an end portion connected to an actuator. A spring is associated with the release slider, biasing the teeth of the release slider into engagement with the grooves in the cavity. A pawl is also arranged within the cavity and removably engages at least one of the grooves in the cavity. A recline link is pivotally connected at a first end to the pawl and pivotally connected at a second end to the stroller.

### FIELD OF INVENTION

This application is generally related to reclinable stroller seats.

### BACKGROUND

Child strollers having reclinable seats often require complex components and can be difficult for a user to move the seat between an upright position and a reclined position. Therefore, a need exists for a reclinable stroller seat that requires few components and provides ease of use for reclining the seat.

### SUMMARY

A stroller having a reclinable seat is disclosed, the reclinable seat having a base connected to the stroller, a seatback pivotally connected to the base, and a seat recline mechanism arranged on the seatback. The seat recline mechanism includes a body defining a cavity having grooves and a release slider arranged within the cavity. The release slider has teeth that correspond to the grooves in the cavity and an end portion connected to an actuator. A spring is associated with the release slider to bias the teeth of the release slider into engagement with the grooves in the cavity. A pawl is also arranged within the cavity and removably engages at least one of the grooves in the cavity. A recline link is pivotally connected to the pawl at a first end and pivotally connected to the stroller at a second end.

In other embodiments of the reclinable seat, the seatback may be pivotally connected to the stroller instead of the base. The seat recline mechanism may further include a guide member arranged within the cavity to house the pawl, the pawl and the recline link being pivotally connected to the guide member and the guide member being movable along the cavity. The seat recline mechanism may be formed integrally with the seatback or alternatively formed as a separate piece and connected to the seatback.

A stroller is also disclosed, the stroller having a stroller frame with at least one front leg, a left rear leg, a right rear leg, and an operator handle having left and right support rails connected to the left and right rear legs, respectively. Each of the legs has a respective wheel mounted thereto. The stroller further includes a reclinable seat having a base supported by the stroller frame, a seatback pivotally connected to the base, and a seat recline mechanism arranged on the seatback. The seat recline mechanism includes a body defining a cavity having grooves and a release slider arranged within the cavity, the release slider having teeth that correspond to the grooves in the cavity and an end portion connected to an actuator adapted to move between a rest position and an activated position. A spring is connected between the actuator and the seatback to bias the teeth of the release slider into engagement with the grooves in the cavity. A pawl is also arranged in the cavity to removably engage at least one of the grooves in the cavity. A recline link is pivotally connected at a first end to the pawl and pivotally connected at a second end to the stroller frame.

For sake of brevity, this summary does not list all aspects of the present invention, which are described in further detail below.

### BRIEF DESCRIPTION OF THE DRAWINGS

The foregoing summary, as well as the following detailed description of the preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangement shown in the drawings.

FIG. 1 is a perspective view of an embodiment of the stroller having a reclinable seat, with the seatback in a fully reclined position and illustrating a complimentary infant travel seat that can be engaged with the stroller.

FIG. 2 is a left elevational view of the stroller shown in FIG. 1, with the complimentary infant travel seat engaged with the stroller and the reclinable seat in a fully reclined position.

FIG. 3 is a fragmentary perspective view of the seatback of the stroller shown in FIG. 1.

FIG. 3a is a fragmentary perspective view of the seatback of the stroller shown in FIG. 1, showing one embodiment of the seat recline mechanism.

FIG. 4 is a fragmentary left elevational view of the stroller shown in FIG. 1, with the reclinable seat in a substantially upright position.

FIG. 5 is a fragmentary left elevational view of the stroller shown in FIG. 1, with the actuator in an activated position.

FIG. 6 is a fragmentary left elevational view of the stroller shown in FIG. 1, with the reclinable seat in a partially reclined position.

FIG. 7 is an exploded view of an alternative embodiment of the seat recline mechanism of the stroller shown in FIG. 1.

FIG. 8 is a back perspective view of the pawl of the seat recline mechanism of the stroller shown in FIG. 1.

FIG. 9 is a back perspective view of the release lever of the seat recline mechanism shown in FIG. 7.

### DETAILED DESCRIPTION OF THE PREFERRED EMBODIMENTS

Certain terminology is used in the following description for convenience only and is not limiting. The words “front,” “rear,” “upper,” “lower,” “left,” and “right” designate directions in the drawings to which reference is made. The words “upward” and “downward” refer to directions towards a higher and lower position from the parts referenced in the drawings. The terminology includes the words specifically noted above, derivatives thereof, and words of similar import.

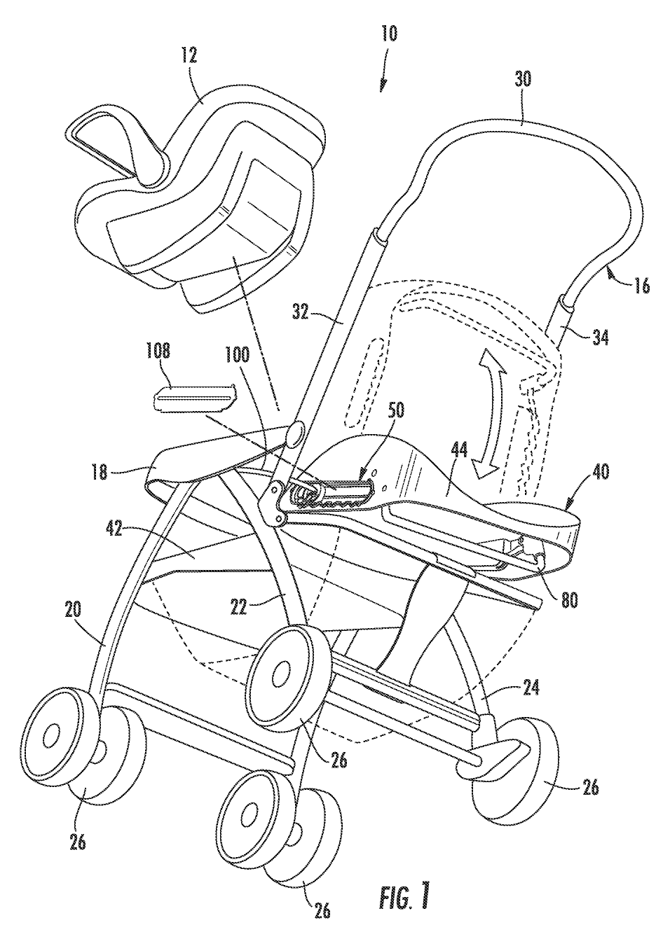

FIG. 1 shows an embodiment of a stroller 10 having a reclinable seat 40 and a complimentary infant travel seat 12 that can be engaged with the stroller 10. The stroller 10 has a stroller frame 16 made up of at least one front leg 20, a left rear leg 22, a right rear leg 24, and an operator handle 30 having a left support rail 32 and a right support rail 34 connected to the left and right rear legs 22, 24, respectively. Each of the legs 20, 22, 24 has a respective wheel 26 mounted thereto. The reclinable seat 40 is supported by the stroller frame 16 and includes a base 42, a seatback 44 pivotally connected to the stroller frame 16 or the base 42, and a seat recline mechanism 50 preferably arranged on the seatback 44. While the reclinable seat 40 may include only one seat recline mechanism 50, two seat recline mechanisms 50 can be arranged on opposing sides of the seatback 44 to provide additional support. The seat recline mechanism 50 has a body 54 that can be formed integrally with the seatback 44 by, for example and without limitation, being molded with the seatback 44. Alternatively, the seat recline mechanism 50 can be formed as a separate piece and connected to the seatback 44 by any suitable means, such as, without limitation, adhesives, fasteners, clips, or a friction fit.

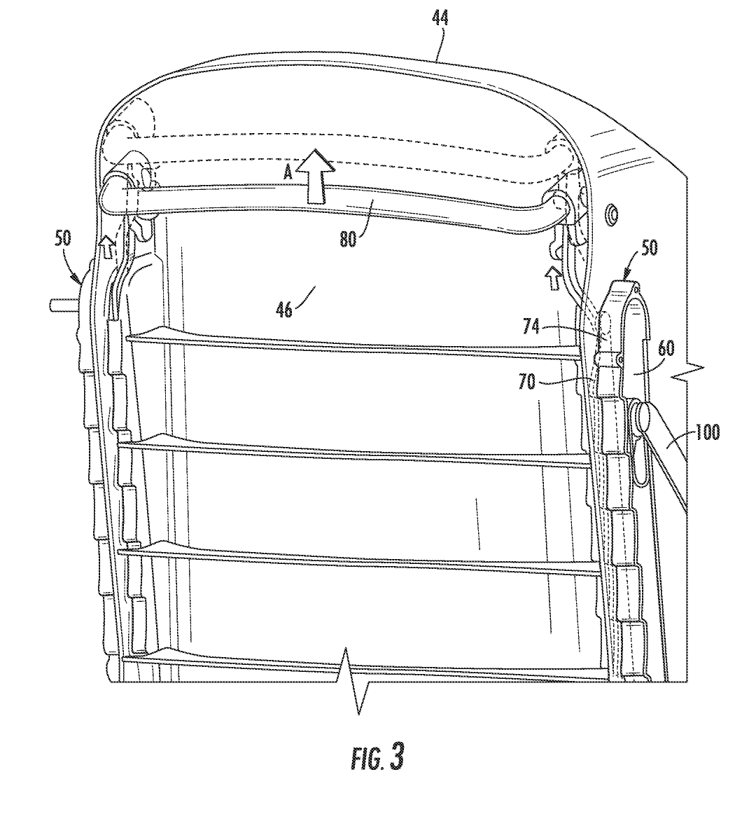

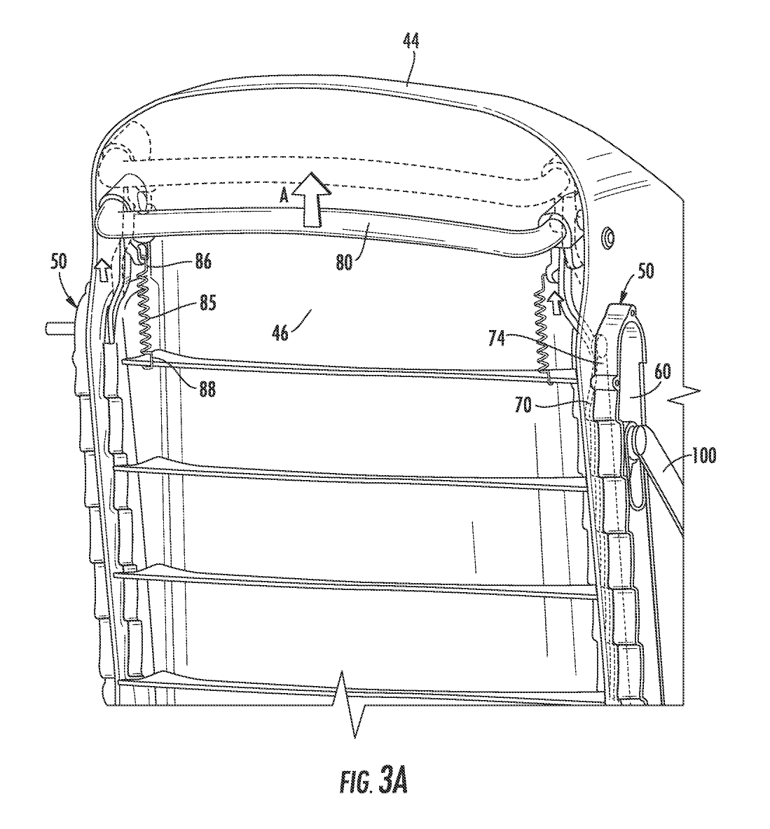

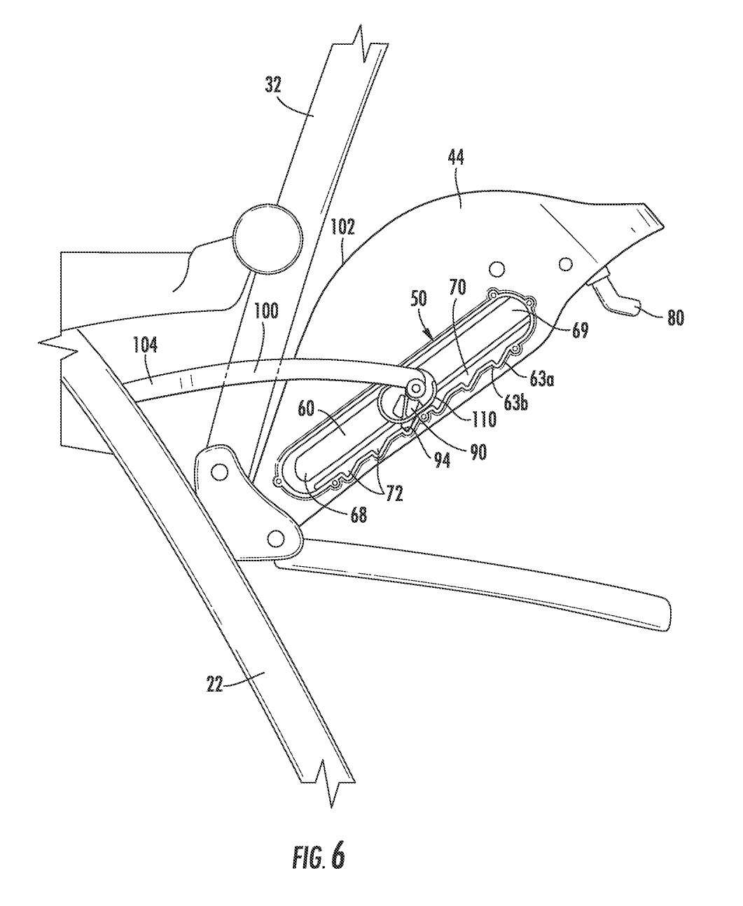

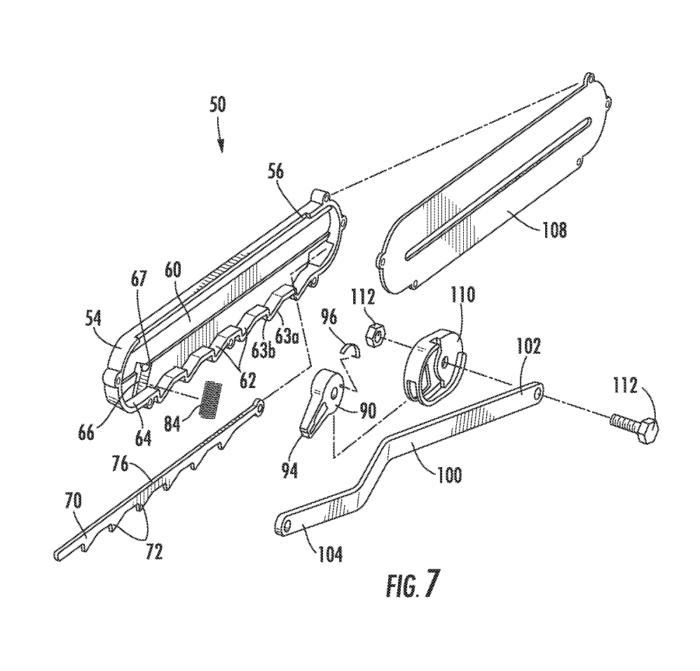

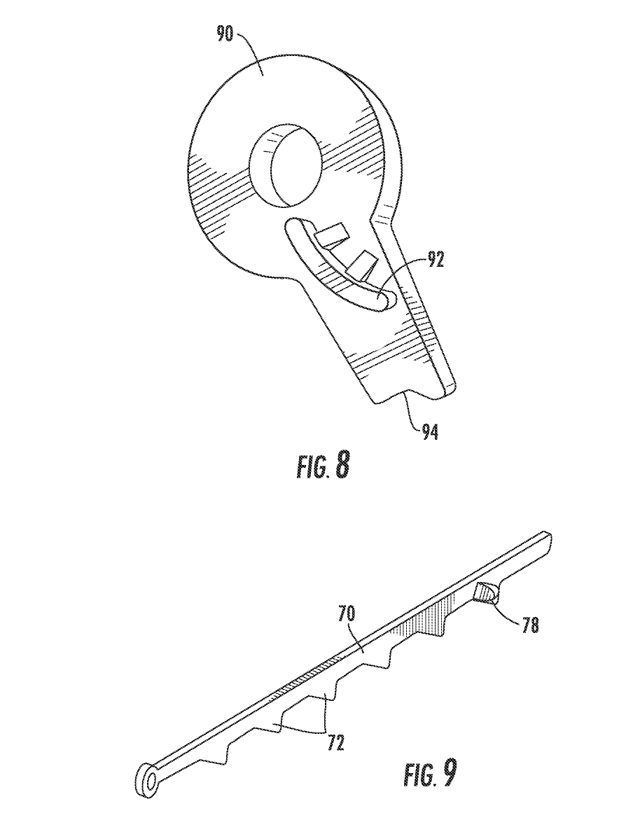

As shown in FIGS. 4-7, the body 54 defines a cavity 60 having grooves 62, which may be defined along a side wall 64 of the cavity 60. A release slider 70 is arranged within the cavity 60. The release slider 70 has teeth 72 that correspond to the grooves 62 in the cavity 60 and an end portion 74 connected to an actuator 80. As shown in FIG. 3, the actuator 80 can be in the form of a handle disposed on a back surface 46 of the seatback 44, which can actuate the seat recline mechanism 50 or two seat recline mechanisms 50 simultaneously if two are utilized. The actuator 80 is adapted to move between a rest position (as shown in solid lines) and an activated position (as shown in phantom). A spring 84,85 is associated with the release slider 70 to bias the teeth 72 of the release slider 70 into engagement with the grooves 62. As shown in FIG. 3a, the spring 85 can have a first end 86 connected to the actuator 80 and a second end 88 connected to the seat back 44. Alternatively, as shown in FIG. 7, the spring 84 is housed in a depression 66 in the cavity 60 and supported between an abutment 78 formed on the release slider 70 (as shown in FIG. 9) and a wall 67 of the depression 66. A pawl 90 is also arranged within the cavity 60 that removably engages at least one of the grooves 62 in the cavity 60. As shown in FIG. 8, the pawl 90 may include an abutment 92 that rests on a guide 76 of the release slider 70. The pawl 90 may further include a spring 96 that biases the pawl into engagement with the at least one of the grooves 62 in the cavity 60. The spring 96 of the pawl 90 may be formed, for example and without limitation, as a leaf spring. A recline link 100 is pivotally connected at a first end 102 to the pawl 90 and pivotally connected at a second end 104 to the stroller frame 16. The second end 104 of the recline link 100 may be connected to, without limitation, a side arm 18 of the stroller, the at least one front leg 20, at least one of the left and right rear legs 22, 24, or at least one of the left and right support rails 32, 34 of the operator handle 30.

A cover 108 can be disposed over the cavity 60 of the body 54 and secured to the body 54 using, without limitation, a fastener, adhesive, or friction fit. When the cover 108 is used, the second end 104 of the recline link 100 extends out of the body 54 through a slot 56 defined between the cover 108 and the body 54. The seat recline mechanism 50 may also include a guide member 110 arranged within the cavity 60 to house the pawl 90. The guide member 110 is movable along the cavity 60. The pawl 90 and the recline link 100 can be pivotally connected to the guide member 110 using a fastener 112 (as shown in FIG. 7) or any other movable connection. The guide member 110 provides additional stability to the pawl 90 as it moves along the cavity 60.

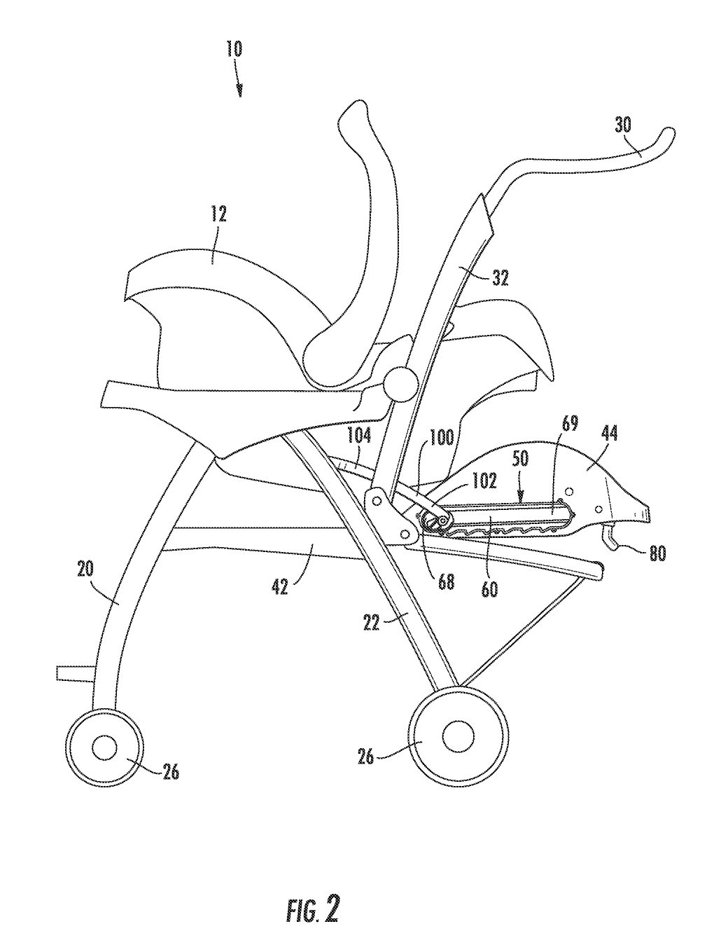

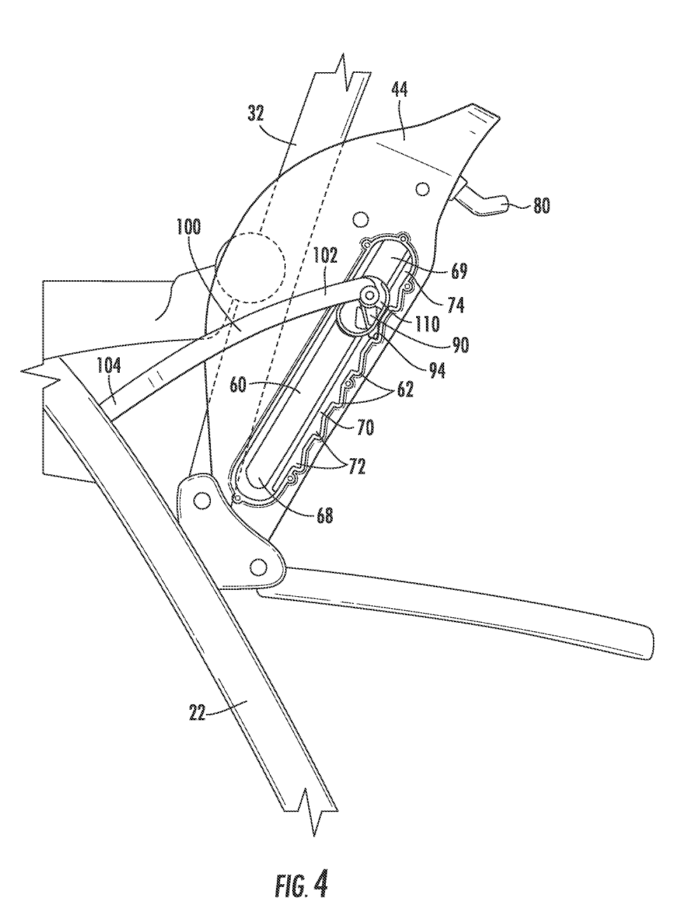

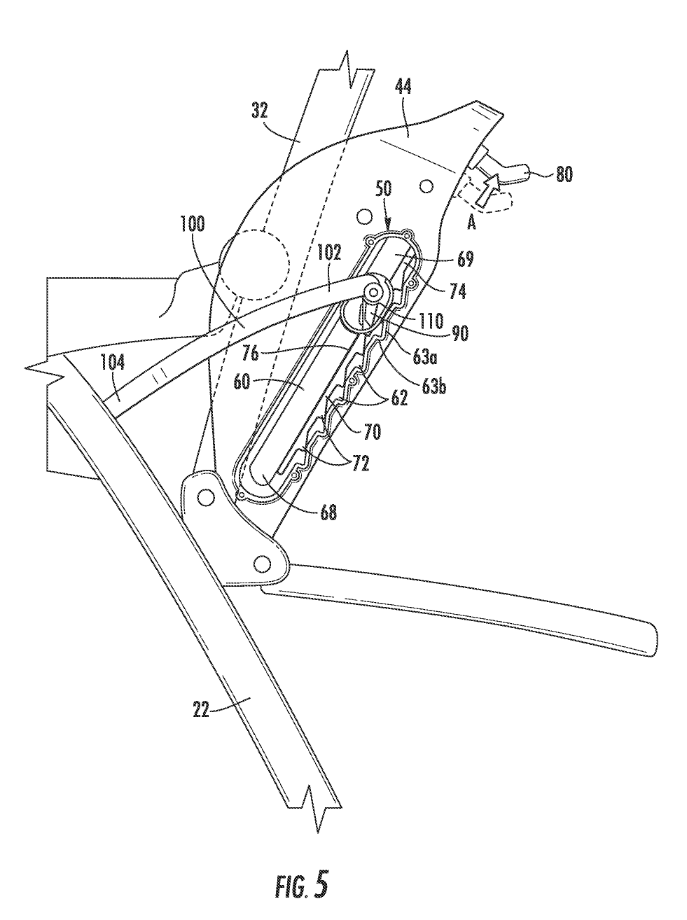

As shown in FIGS. 4-6, the seat recline mechanism 50 is arranged such that the cavity 60 has a lower end 68 adjacent to a pivotal connection between the seatback 44 and the stroller frame 16, and an opposing upper end 69. The side wall 64 of the cavity 60 in which the grooves 62 are defined extends between the lower and upper ends 68, 69 of the cavity 60. The seatback 44 is in an upright position (as shown in phantom in FIG. 1) when the pawl 90 is at the upper end 69 of the cavity 60, and a fully reclined position (as shown in FIGS. 1 and 2) when the pawl 90 is at the lower end 68 of the cavity 60. As shown in FIGS. 3 and 5, the actuator 80 can be moved from the rest position to the activated position by applying an upward force in the direction of arrow A. The seatback 44 is pivotable between the upright position and the fully reclined position when the actuator 80 is in the activated position. As shown in FIG. 5, when the actuator 80 is moved from the rest position (shown in phantom) to the activated position (shown in solid lines), the release slider 70 moves towards the upper end 69 of the cavity 60, causing the teeth 72 of the release slider 70 to disengage from the grooves 62 in the cavity 60. Since the pawl 90 includes the abutment 92 that rests on the guide 76 of the release slider 70, the movement of the release slider 70 in turn moves the pawl 90 upward into disengagement from the at least one of the grooves 62 in the cavity 60. When the actuator 80 is in the activated position, the seatback 44 can be moved between the upright and fully reclined positions. When the actuator 80 returns to the rest position, as shown in FIG. 6, the teeth 72 of the release slider 70 reengage with the grooves 62 of the cavity 60 and the pawl 90 reengages with at least one of the grooves 62, locking the seatback 44 in a desired position.

As shown in FIGS. 4-7, each one of the grooves 62 in the cavity 60 has a first portion 63a that is angled upwardly towards the upper end 69 of the cavity 60. Because of the moderate slope of the first portion 63a and the shape of the pawl 90, the pawl 90 can slide up and over the first portion 63a of the grooves 62 as the pawl 90 moves towards the upper end 69 of the cavity. As the pawl 90 moves out of one of the grooves 62, the spring 96 connected to the pawl 90 biases it into the next groove. Therefore, when the seatback 44 is between the upright and the fully reclined position or in the fully reclined position, the seatback 44 can be pivoted towards the upright position while the actuator 80 is in the rest position. Each one of the grooves 62 in the cavity 60 also has a second portion 63b that is angled upwardly towards the lower end 68 of the cavity, but with a steeper slope than the first portion 63a. The second portion 63b of the grooves 62 may even be substantially perpendicular to the side wall 64 of the cavity 60. In other words, the second portion 63b of each one of the grooves 62 has a greater slope than the first portion 63a of each one of the grooves. The pawl 90 is formed with a catch 94 that engages the second portion 63b of the first one of the grooves 62 it encounters, thus locking the pawl 90 against that groove and preventing any movement towards the lower end 68 of the cavity 60 while the actuator 80 is in the rest position. Therefore, the actuator 80 must be in the activated position to pivot the seatback 44 towards the fully reclined position, but not to pivot the seatback 44 towards the upright position.

The stroller frame 16 can be folded into a storage position for compact storage and can be unfolded into a use position. Due to the connection between the seatback 44 and the stroller frame 16, the seatback 44 can maintain its last recline position when the stroller 10 is moved between the storage and use positions.

While various methods, configurations, and features of the present invention have been described above and shown in the drawings, one of ordinary skill in the art will appreciate from this disclosure that any combination of the above features can be used without departing from the scope of the present invention. It is also recognized by those skilled in the art that changes may be made to the above described methods and embodiments without departing from the broad inventive concept thereof.

What is claimed is:

1. A stroller having a reclinable seat, the reclinable seat comprising:
a base connected to the stroller;
a seatback pivotally connected to the base; and
a seat recline mechanism arranged on the seatback, the seat recline mechanism comprising:
a body defining a cavity having grooves;
a release slider arranged within the cavity, the release slider having teeth that correspond to the grooves and an end portion connected to an actuator;
a spring associated with the release slider to bias the teeth of the release slider into engagement with the grooves;
a pawl arranged within the cavity that removably engages at least one of the grooves; and
a recline link having a first end pivotally connected to the pawl and a second end pivotally connected to the stroller.

2. The stroller of claim 1, wherein the actuator is disposed on a back surface of the seatback.

3. The stroller of claim 1, further comprising a cover disposed over the cavity, wherein the second end of the recline link extends out of the cavity through a slot defined between the cover and the body

4. The stroller of claim 1, further comprising a guide member arranged within the cavity to house the pawl, the pawl and the recline link being pivotally connected to the guide member and the guide member being movable along the cavity.

5. The stroller of claim 1, wherein the spring is housed in a depression in the cavity and supported between an abutment formed on the release slider and a wall of the depression.

6. The stroller of claim 1, wherein the spring has a first end connected to the actuator and a second end connected to the seatback.

7. The stroller of claim 1, wherein the pawl includes an abutment that rests on a guide surface of the release slider and a spring that biases the pawl into engagement with the at least one of the grooves.

8. The stroller of claim 1, wherein the seat recline mechanism is formed integrally with the seatback.

9. The stroller of claim 1, wherein the seat recline mechanism is formed as a separate piece and connected to the seatback.

10. The stroller of claim 1, wherein the stroller has a frame comprising at least one front leg, a pair of rear legs, and an operator handle, and the second end of the recline link is connected to a component of the stroller frame selected from the group consisting of a side arm, a leg, and an operator handle support rail.

11. The stroller of claim 1, wherein the actuator is adapted to move between a rest position and an activated position.

12. The stroller of claim 11, wherein the cavity has a lower end adjacent to a pivotal connection between the seatback and the base and an opposing upper end, the seatback being in an upright position when the pawl is at the upper end of the cavity, and a fully reclined position when the pawl is at the lower end of the cavity.

13. The stroller of claim 12, wherein the seatback is pivotable between the upright position and the fully reclined position when the actuator is in the activated position.

14. The stroller of claim 13, wherein when the actuator is in the activated position, the release slider is movable towards the upper end of the cavity, the teeth of the release slider are disengagable from the grooves, and the pawl is disengagable from the at least one of the grooves.

15. The stroller of claim 14, wherein each one of the grooves has a first portion angled upwardly towards the upper end of the cavity and the pawl is arranged to be slidable along the first portion of each one of the grooves as the pawl moves towards the upper end of the cavity, allowing the seatback to be pivoted towards the upright position while the actuator is in the rest position.

16. The stroller of claim 15, wherein each one of the grooves has a second portion angled upwardly towards the lower end of the cavity and the pawl includes a catch that engages the second portion of at least one of the grooves and prevents movement of the pawl towards the lower end of the cavity while the actuator is in the rest position.

17. The stroller of claim 16, wherein the second portion of each one of the grooves has a slope that is greater than a slope of the first portion of each one of the grooves.

18. A stroller having a reclinable seat, the reclinable seat comprising:
a base connected to the stroller;
a seatback pivotally connected to the stroller; and
a seat recline mechanism arranged on the seatback, the seat recline mechanism comprising:
a body defining a cavity, the body having a wall defining grooves;
a release slider arranged within the cavity, the release slider having teeth that correspond to the grooves and an end portion connected to an actuator;
a spring connected between the actuator and the seatback to bias the teeth of the release slider into engagement with the grooves;
a pawl arranged within the cavity that removably engages at least one of the grooves; and
a recline link having a first end pivotally connected to the pawl and a second end pivotally connected to the stroller.

19. A stroller comprising:
a stroller frame having at least one front leg, a left rear leg, a right rear leg, each of the legs having a respective wheel mounted thereto, an operator handle having left and right support rails connected to the left and right rear legs, respectively; and
a reclinable seat having a base supported by the stroller frame, a seatback pivotally connected to the base, and a seat recline mechanism arranged on the seatback, the seat recline mechanism comprising:
a body defining a cavity, the body having a wall defining grooves;
a release slider arranged within the cavity, the release slider having teeth that correspond to the grooves and an end portion connected to an actuator adapted to move between a rest position and an activated position;
a spring connected between the actuator and the seatback to bias the teeth of the release slider into engagement with the grooves;
a pawl arranged within the cavity that removably engages at least one of the grooves; and
a recline link having a first end pivotally connected to the pawl and a second end pivotally connected to the stroller frame.

20. The stroller of claim 19, wherein the seatback is in a fully reclined position when the pawl is at a lower end of the cavity adjacent to the base of the reclinable seat, and the seatback is in an upright position when the pawl is at an opposing upper end of the cavity,
when the actuator is in the activated position, the release slider is movable towards the upper end of the cavity, the teeth of the release slider are disengagable from the grooves, and the pawl is disengagable from the at least one of the grooves.
